(19) United States
(12) Patent Application Publication
(10) Pub. No.: US 2026/0108336 A1
(43) Pub. Date: Apr. 23, 2026

(54) DRIVE APPARATUS FOR ORAL CAVITY CLEANING, BRUSH HANDLE ASSEMBLY, AND AXIAL AUXILIARY MEMBER

(71) Applicant: Shenzhen Soocas Technology Co., Ltd., Shenzhen (CN)

(72) Inventors: Mengwei ZENG, Shenzhen (CN); Bin DONG, Shenzhen (CN); Yanqiang LI, Shenzhen (CN); Yi XIE, Shenzhen (CN); Zhoujian LI, Shenzhen (CN)

(73) Assignee: Shenzhen Soocas Technology Co., Ltd., Shenzhen (CN)

(21) Appl. No.: 19/427,350

(22) Filed: Dec. 19, 2025

Related U.S. Application Data
(63) Continuation of application No. PCT/CN2025/114231, filed on Aug. 12, 2025.

(30) Foreign Application Priority Data
Sep. 24, 2024 (CN) 2024113395366

(51) Int. Cl. A61C 17/34; A46B 13/02; A46B 13/04; A61C 17/024

(52) U.S. Cl. CPC A61C 17/34; A46B 13/023; A46B 13/04; A61C 17/024

(57) ABSTRACT

The present disclosure discloses a drive apparatus for oral cavity cleaning, a brush handle assembly, and an axial auxiliary member. The drive apparatus at least includes a housing component, a power output shaft, an axial drive component, an axial auxiliary component, and a servo rotating assembly. The housing component extends along a first axis and has an accommodation chamber. The power output shaft extends along the first axis and separately passes through the axial drive component, the axial auxiliary component and the servo rotating assembly, and at least one end of the power output shaft extends out of the housing component. The axial auxiliary component is connected to the power output shaft and the housing component, respectively.

### CROSS REFERENCE TO RELATED APPLICATION

This application is a continuation of International Application No. PCT/CN2025/114231, filed on Aug. 12, 2025, which claims priority to Chinese Patent Application No.2024113395366 titled “DRIVE APPARATUS FOR ORAL CAVITY CLEANING, BRUSH HANDLE ASSEMBLY, AND AXIAL AUXILIARY MEMBER” and filed to the State Patent Intellectual Property Office on Sep. 24, 2024, the entire contents of which are incorporated herein by reference.

### TECHNICAL FIELD

The present disclosure relates to the field of oral cleaning appliance technology, and more particularly, to a drive apparatus for oral cavity cleaning, a brush handle assembly, and an axial auxiliary member.

### BACKGROUND

With the continuous improvement of people's living standards, electric toothbrushes begin to appear in people's daily life, replacing traditional toothbrushes to achieve more ideal and more convenient tooth brushing effects.

However, for the electric toothbrushes on the market, a small angle of rotary swing is generated mainly through rotation of output shafts on the electric toothbrushes around axes thereof, thereby driving brush heads to reciprocate to clean teeth. However, in this method, the brush heads cannot provide more desired movements to provide more efficient and more comprehensive tooth cleaning and to help users maintain good oral hygiene.

### SUMMARY

Objectives of the present disclosure are to provide a drive apparatus for oral cavity cleaning, a brush handle assembly, and an axial auxiliary member.

To achieve the above objectives, in one aspect the present disclosure provides a drive apparatus for oral cavity cleaning. The drive apparatus for oral cavity cleaning at least includes a housing component, a power output shaft, an axial drive component, an axial auxiliary component, and a servo rotating assembly. The housing component extends along a first axis and has an accommodation chamber. The axial drive component, the axial auxiliary component, and the servo rotating assembly are arranged along the first axis, and the axial auxiliary component and the servo rotating assembly are at least partially positioned in the accommodation chamber. The power output shaft extends along the first axis and passes through the axial drive component, the axial auxiliary component, and the servo rotating assembly, respectively, and at least one end of the power output shaft extends out of the housing component. The axial auxiliary component is connected to the power output shaft and the housing component, respectively. When the axial drive component drives the power output shaft to move along the first axis, the axial auxiliary component is configured to move along the first axis against the power output shaft, to limit a movement range of the power output shaft on the first axis.

Optionally, the axial auxiliary component includes a first auxiliary member, where the first auxiliary member includes an inner connecting portion rotatably connected to the power output shaft and a deformation portion connecting the inner connecting portion and the housing component. When the axial drive component drives the power output shaft to move along the first axis, a driving force of the axial drive component overcomes an elastic force of the deformation portion to cause elastic deformation of the deformation portion, and the elastic force of the deformation portion limits the movement range of the power output shaft on the first axis.

Optionally, the first auxiliary member also includes an outer connecting portion, where the outer connecting portion is connected to the inner connecting portion by means of the deformation portion to form an integrated structure, such that the deformation portion is connected to the housing component by means of the outer connecting portion.

Optionally, the deformation portion (412) includes a deformation body, where the deformation body, the inner connecting portion, and the outer connecting portion are annular in shape and are coaxially spaced apart from each other, and the deformation body is positioned between the inner connecting portion and the outer connecting portion. An outer wall face of the deformation body is connected to an inner wall face of the outer connecting portion by means of at least two first connecting arms, and an inner wall face of the deformation body is connected to an outer wall face of the inner connecting portion by means of at least two second connecting arms.

Optionally, the at least two first connecting arms are arranged in an annular array taking an axis of the deformation body as a center, and the at least two second connecting arms are arranged in an annular array taking the axis of the deformation body as a center.

Optionally, two of the first connecting arms and two of the second connecting arms are provided, and a connecting line between the two first connecting arms is perpendicular to a connecting line between the two second connecting arms.

Optionally, part of the deformation body positioned between any adjacent two of the first connecting arms and the second connecting arms is defined as a deformation segment; and along an extension direction of the deformation segment, a thickness of the deformation segment gradually increases from a middle region of the deformation segment to two ends of the deformation segment.

Optionally, a thickness (D1) between the two ends of the deformation segment ranges between 0.7 mm and 1.1 mm; and a thickness (D2) of the middle region of the deformation segment ranges between 0.3 mm and 0.5 mm.

Optionally, a width (D3) of the first connecting arm and a width (D3) of the second connecting arm both range between 1.3 mm and 1.8 mm.

Optionally, the axial auxiliary component also includes a first bearing, where an inner ring of the first bearing is sleeved on the power output shaft, and an outer ring of the first bearing is fixedly connected to the inner connecting portion, such that the inner connecting portion is rotatably connected to the power output shaft by means of the first bearing.

Optionally, the inner connecting portion is annular in shape, and the inner connecting portion is provided with a first opening and a second opening at two ends along the first axis, respectively. One end of the inner connecting portion adjacent to the first opening is provided with a carrying portion, and the carrying portion extends radially inward from an inner wall face of the inner connecting portion.

Optionally, the first bearing is installed into an interior of the inner connecting portion through the second opening, and the carrying portion abuts against the outer ring of the first bearing, and the carrying portion does not extend to the inner ring of the first bearing.

Optionally, in a direction parallel to the first axis, the deformation portion is arranged adjacent to the carrying portion.

Optionally, the axial auxiliary component also includes a second auxiliary member. The first auxiliary member and the second auxiliary member are arranged along the first axis, where the first auxiliary member and the second auxiliary member have a same structure and are symmetrically arranged about a middle plane between the first auxiliary member and the second auxiliary member.

Optionally, the servo rotating assembly includes a rotary drive component and a motion detection component, where the rotary drive component includes a stator element and a rotor element, the stator element is fixedly connected to the housing component, and the rotor element is fixedly connected to the power output shaft. The motion detection component positioned at least partially in the accommodation chamber includes a motion detection member and a motion feedback member, where the motion detection member is directly connected to the stator element, the motion feedback member is connected to the power output shaft and rotates with the power output shaft, and the motion detection member is configured to detect a rotational position of the power output shaft by means of the motion feedback member.

Optionally, the stator element includes a stator bracket and a surface covering element, where the surface covering element at least covers the stator bracket, and the motion detection member is connected to the surface covering element.

Optionally, the axial drive component includes a primary element and a secondary element, where the primary element is fixedly connected to the housing component, the secondary element is annular in shape, and the secondary element is sleeved on the power output shaft and rotates with the power output shaft.

To achieve the above objectives, in another aspect the present disclosure also provides a brush handle assembly, which at least includes a grip housing, an energy storage member installed inside the grip housing, and the drive apparatus for oral cavity cleaning. The energy storage member is electrically connected to the drive apparatus, and the power output shaft of the drive apparatus extends out of the grip housing.

Optionally, the power output shaft has an axial channel and a fluid inlet and a fluid outlet communicating with the axial channel.

To achieve the above objectives, in yet another aspect the present disclosure also provides an oral cleaner, which at least includes an oral care head and the brush handle assembly, where the oral care head is detachably connected to the power output shaft.

To achieve the above objectives, in still another aspect the present disclosure also provides an oral cleaner, which at least includes an oral care head and the brush handle assembly, where the oral care head has a fluid channel and an outlet communicating with the fluid channel. The power output shaft is connected to the oral care head and drives the oral care head to perform a displacement motion, and a fluid outlet of the axial channel communicates with the fluid channel, and the oral cleaner outputs water flow impact through the outlet.

To achieve the above objectives, in still another aspect the present disclosure also provides an axial auxiliary member, which at least includes an inner connecting portion, a deformation portion, and an outer connecting portion. The inner connecting portion and the outer connecting portion are both annular in shape, the inner connecting portion is positioned inside the outer connecting portion, and the inner connecting portion is coaxially spaced apart from the outer connecting portion. The deformation portion is separately connected to the inner connecting portion and the outer connecting portion, and the deformation portion has elastic properties.

Optionally, the deformation portion includes a deformation body, where the deformation body is positioned between the inner connecting portion and the outer connecting portion, and the deformation body is coaxially spaced apart from the inner connecting portion and the outer connecting portion, respectively. An outer wall face of the deformation body is connected to an inner wall face of the outer connecting portion by means of at least two first connecting arms, and an inner wall face of the deformation body is connected to an outer wall face of the inner connecting portion by means of at least two second connecting arms.

Optionally, two of the first connecting arms and two of the second connecting arms are provided, and a connecting line between the two first connecting arms is perpendicular to a connecting line between the two second connecting arms.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic perspective view of a drive apparatus according to an embodiment of the present disclosure;

FIG. 2 is a schematic half-sectional view of a drive apparatus according to an embodiment of the present disclosure;

FIG. 3 is a schematic half-sectional view after a first auxiliary member is connected to a first bearing according to an embodiment of the present disclosure;

FIG. 4 is a schematic front view of a first auxiliary member according to an embodiment of the present disclosure;

FIG. 5 is a schematic front view of a deformation portion according to an embodiment of the present disclosure;

FIG. 6 is a schematic perspective view of a deformation portion according to an embodiment of the present disclosure;

FIG. 7 is a schematic half-sectional view after a servo rotating assembly is connected to a power output shaft according to an embodiment of the present disclosure;

FIG. 8 is a schematic perspective view after a stator element is connected to a motion detection component according to an embodiment of the present disclosure;

FIG. 9 is a schematic half-sectional view of a partial structure of a drive apparatus according to an embodiment of the present disclosure;

FIG. 10 is a schematic diagram of a brush handle assembly according to an embodiment of the present disclosure; and

FIG. 11 is a schematic diagram of an oral cleaner according to an embodiment of the present disclosure.

Reference numerals in the accompanying drawings:
housing component 100; first axis 101; accommodation chamber 102; outer housing 110; attachment segment 120;
power output shaft 200; axial channel 210;
axial drive component 300; primary element 310; secondary element 320;
axial auxiliary component 400; first auxiliary member 410; inner connecting portion 411; deformation portion 412; deformation body 4121; deformation segment 41211; first connecting arm 4122; second connecting arm 4123; outer connecting portion 413; carrying portion 414; first bearing 420; second auxiliary member 430;
servo rotating assembly 500; rotary drive component 510; stator element 511; stator bracket 5111; surface covering element 5112; rotor element 512; motion detection component 520; motion detection member 521; motion feedback member 522;
grip housing 610; energy storage member 620; liquid storage chamber 630; fluid pumping unit 640; oral care head 650; fluid channel 651; and outlet 652.

### DETAILED DESCRIPTION

As described in the background technology, for an electric toothbrush on the market, a small angle of rotary swing is generated mainly through rotation of an output shaft of a drive apparatus on the electric toothbrush around an axis thereof, thereby driving a brush head to reciprocate to clean teeth. For example, in related technologies, the drive apparatus inside the electric toothbrush uses a sonic wave motor. When the sonic wave motor swings at a high frequency, the output shaft of the sonic wave motor swings around a direction of rotation of the output shaft, without an axial motion or a combination of axial and rotational motions, resulting in single action and monotonous function. Correspondingly, the brush head connected to the output shaft of the sonic wave motor only is capable of swinging cleaning in a direction of rotation, lacking horizontal cleaning effect, resulting in insufficient cleaning force or dead corners between tooth surfaces and tooth gaps, thus leading to poor cleaning effects.

In response to the above technical problems, inventors of the present disclosure propose to additionally provide an axial drive component on the basis of the drive apparatus that can output a rotational function on the output shaft. The axial drive component drives the output shaft to linearly move back and forth in its axial direction, which allows the brush head to simultaneously perform an axial motion and a rotational motion, and a compound motion combining the axial motion and the rotational motion. to provide more desired motions, meet different cleaning needs, and improve the oral cleaning effects. Furthermore, in the present disclosure, a rotary drive component for driving the output shaft to rotate is additionally provided with a Hall sensor, which can achieve high-precision and high repeatability control over positions, speeds, and torques during the rotation process. It has fast dynamic response and tracking performance, can reach a set speed in a short time and accurately track commands, and can achieve smooth speed regulation in a wide range of speeds, thereby further improving the user experience.

However, to meet oral cleaning needs of a user and to ensure that a sensing distance between the Hall sensor and an induction magnet does not fail due to a farther distance, an axial motion distance of the output shaft generally is controlled at about 1 mm. However, the relevant axial drive component cannot achieve such precise reciprocating motion. Therefore, in the present disclosure, an axial auxiliary member is further additionally provided inside the drive apparatus to assist the output shaft in achieving the axial reciprocating motion without adversely affecting drive of the rotary drive component and induction control by the Hall sensor and the induction magnet. In this way, it is ensured that the brush head can provide more movement directions, to improve the oral cleaning effects and ensure reliable and stable movement of the drive apparatus.

To make the objectives, technical solutions, and advantages of the embodiments of the present disclosure clearer, the technical solutions in the embodiments of the present disclosure will be described clearly and completely below, in conjunction with the accompanying drawings in the embodiments of the present disclosure. Apparently, the described embodiments are some but not all of the embodiments of the present disclosure.

The present disclosure provides a drive apparatus, which may be used for oral cleaning. For example, the drive apparatus may be used as a power source and may be used in an electric toothbrush or an integrated rinsing machine to drive a brush head of the electric toothbrush or integrated rinsing machine to perform an axial motion and/or high-frequency vibration and/or reciprocating swing, to improve cleaning efficiency. Of course, the drive apparatus may also be used in other cleaning equipment requiring for the axial motion and/or high-frequency vibration and/or reciprocating swing, but the present disclosure is not limited thereto.

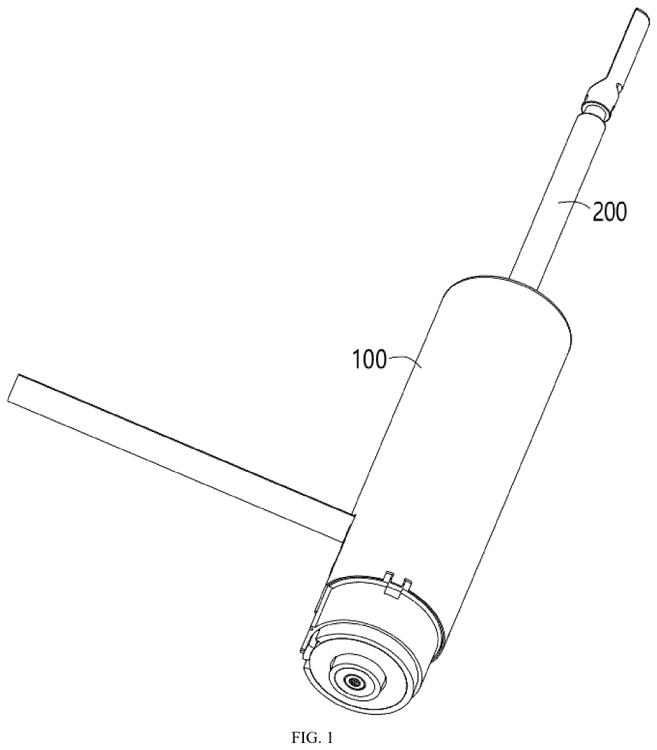

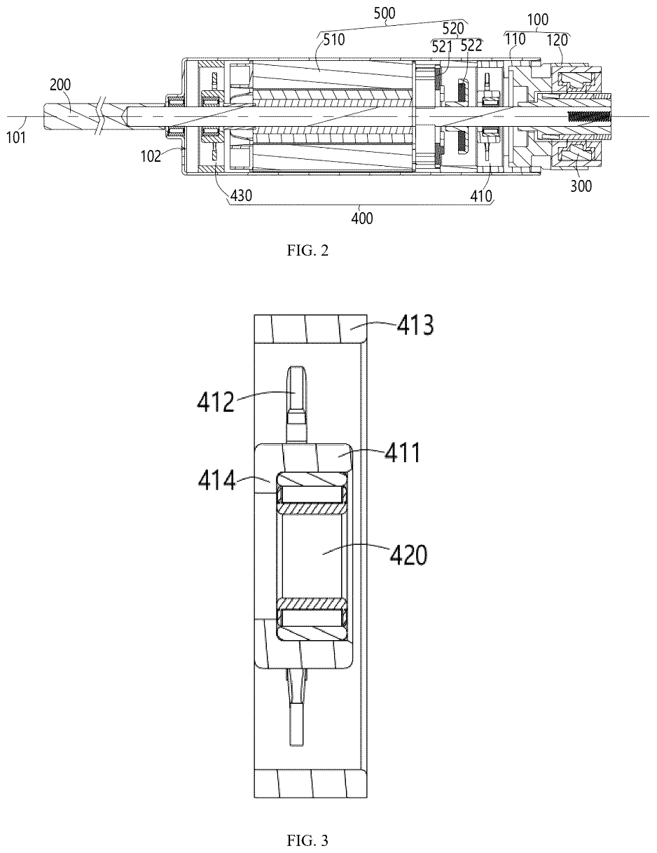

Specifically, referring to FIGS. 1 to 2, in one implementable embodiment, the drive apparatus may at least include a housing component 100, which serves as a main body member of the drive apparatus. The housing component 100 is mainly used to support and/or protect other parts of the drive apparatus. The housing component 100 may be configured as a cylinder shape, and the first axis 101 may be a centerline of the housing component 100. That is, a center of gravity of each cross-section of the housing component 100 may be positioned on the first axis 101, and the housing component 100 may extend along the first axis 101. The housing component 100 encloses to form an accommodation chamber 102.

In this embodiment, the drive apparatus may also include a power output shaft 200, an axial drive component 300, an axial auxiliary component 400, and a servo rotating assembly 500. The power output shaft 200, the axial drive component 300, the axial auxiliary component 400, and the servo rotating assembly 500 are installed inside the housing component 100. The servo rotating assembly 500 is used to drive the power output shaft 200 to swing back and forth around the first axis 101. Furthermore, the servo rotating assembly 500 integrates a servo control function, such that an rotation speed, an angle and a torque of the power output shaft 200 and/or a rotational position of the power output shaft 200 may be accurately detected to perform a steering operation, and then the power output shaft 200 is controlled to swing in a reverse direction at a preset position, to adjust parameters according to actual needs of the user to obtain more desired motions. The axial drive component 300 is used to drive the power output shaft 200 to linearly move back and forth along the first axis 101. The axial auxiliary component 400 is connected to the power output shaft 200 and the housing component 100, respectively. When the axial drive component 300 drives the power output shaft 200 to move along the first axis 101, the axial auxiliary component 400 is configured to move along the first axis 101 against the power output shaft 200, to limit a movement range of the power output shaft 200 on the first axis 101, thereby avoiding a problem that the axial drive component 300 cannot drive the power output shaft 200 to move in an opposite direction because the movement range of the power output shaft 200 is larger, and avoiding a problem of poor detection accuracy caused by a farther distance of the motion detection component of the servo rotating assembly 500, to ensure that the axial drive component 300 may stably drive the power output shaft 200 to move back and forth, and to ensure accuracy of a detection function of the servo rotating assembly 500.

In practical applications, the axial drive component 300 may be positioned at least partially in the accommodation chamber 102, and the axial drive component 300 may also be external to the accommodation chamber 102. The axial auxiliary component 400 and the servo rotating assembly 500 are at least partially positioned in the accommodation chamber 102, and the axial drive component 300, the axial auxiliary component 400 and the servo rotating assembly 500 are arranged along the first axis 101. The power output shaft 200 extends along the first axis 101 and passes through the axial drive component 300, the axial auxiliary component 400, and the servo rotating assembly 500, respectively, and at least one end of the power output shaft 200 extends out of the housing component 100. The axial auxiliary component 400 may be directly connected to the housing component 100, or the axial auxiliary component 400 may be indirectly connected to the housing component 100 by means of a mounting bracket inside the housing component 100, but the present disclosure is not limited thereto.

It is worth mentioning that compared to the related technologies where the power output shaft 200 can only perform a single swinging motion, in the present disclosure, the axial auxiliary component 300 and the servo rotating assembly 500 are simultaneously integrated in the drive apparatus. The axial drive component 300 drives the power output shaft 200 to linearly move back and forth in its axial direction, and the servo rotating assembly 500 drives the power output shaft 200 to swing back and forth. This allows the power output shaft 200 to simultaneously perform an axial motion and a rotational motion, and a compound motion combining the axial motion and the rotational motion. When the drive apparatus is used in oral cleaners such as electric toothbrushes and integrated rinsing machines, the improvement scheme of the present disclosure can greatly enrich motion types of brush heads, such that the brush heads not only can achieve high-frequency vibration and swing by means of rotation, but also can achieve the high-frequency vibration and swing by means of the axial motion, or achieve the compound motion based on any combination of the four motions, to provide more desired motions, meet different cleaning needs, and improve the oral cleaning effects. Furthermore, the servo rotating assembly 500 integrates the servo control function, which can achieve high-precision and high repeatability control over positions, speeds, and torques during the process of driving the brush head to rotate by means of the servo rotating assembly 500. It has fast dynamic response and tracking performance, can reach a set speed in a short time and accurately track commands, and can achieve smooth speed regulation in a wide range of speeds, thereby further improving the user experience.

Moreover, the drive apparatus also integrates the axial auxiliary component 400 for limiting the movement range of the power output shaft 200 on the first axis 101, to ensure that the power output shaft 200 can stably move back and forth in the axial direction without adversely affecting drive of the servo rotating assembly 500 and detection control of the motion detection component thereof. In this way, it is ensured that the brush head can provide more movement directions, to improve the oral cleaning effects and ensure reliable and stable movement of the drive apparatus.

Regarding to the specific structure of the axial auxiliary component 400, in one implementable embodiment, the axial auxiliary component 400 may have a limiting slot, and the power output shaft 200 is provided with an extension block positioned within the limiting slot. When the power output shaft 200 moves back and forth along the first axis 101, an inner side wall of the limiting slot may touch and stop the extension block to resist the movement of the power output shaft 200 along the first axis 101, thereby limiting the movement range of the power output shaft 200 on the first axis 101.

In practical applications, considering existence of the rotational motion of the power output shaft 200, the extension block and/or the limiting slot may be configured as an annular or arc-shaped structure. This ensures that the extension block remains within the limiting slot regardless of a rotational angle of the power output shaft 200.

As shown in FIGS. 2 to 4, in another alternative embodiment, the axial auxiliary component 400 may include a first auxiliary member 410, which includes an inner connecting portion 411 and a deformation portion 412. The inner connecting portion 411 is rotatably connected to the power output shaft 200, and there is no relative motion, along a direction of the first axis 101, between the inner connecting portion 411 and the power output shaft 200. The deformation portion 412 is used to connect the inner connecting portion 411 to the housing component 100. In this way, when the axial drive component 300 drives the power output shaft 200 to move along the first axis 101, a driving force of the axial drive component 300 may overcome an elastic force of the deformation portion 412 to cause elastic deformation of the deformation portion 412. That is, the elastic deformation of the deformation portion 412 may be utilized to drive the power output shaft 200 to move along the first axis 101. Furthermore, as a degree of deformation of the deformation portion 412 increases, the elastic force of the deformation portion 412 also gradually increases. When the driving force generated by the axial drive component 300 is smaller than the elastic force of the deformation portion 412, the elastic force of the deformation portion 412 may be utilized to limit the further movement of the power output shaft 200. In this way, the elastic force of the deformation portion 412 may limit the movement range of the power output shaft 200 on the first axis 101.

In this way, the first auxiliary member 410 may utilize the elastic force of the deformation portion 412 to limit the movement range of the power output shaft 200 on the first axis 101, thereby ensuring that the power output shaft 200 may move back and forth stably in the axial direction without adversely affecting drive of the servo rotating assembly 500 and detection control of the motion detection component thereof. In this way, it is ensured that the drive apparatus may reliably and stably move while providing more motion directions for the brush head to improve the oral cleaning effects. Moreover, the first auxiliary member 410 may also utilize its own rigidity ability to prevent, when there is no need to move along the first axis 101, the power output shaft 200 from moving along the first axis 101 and from adversely affecting the user experience.

To facilitate an installation operation of the first auxiliary member 410, in one implementable embodiment, the first auxiliary member 410 may also include an outer connecting portion 413, and the outer connecting portion 413 is connected to the inner connecting portion 411 by means of the deformation portion 412 to form an integrated structure. In this way, the outer connecting portion 413, the deformation portion 412, and the inner connecting portion 411 may be installed as a whole into the accommodation chamber 102, thereby facilitating the installation operation. Correspondingly, when the outer connecting portion 413, the deformation portion 412, and the inner connecting portion 411 are installed as a whole into the accommodation chamber 102, the deformation portion 412 may be connected to the housing component 100 by means of the outer connecting portion 413, such that the outer connecting portion 413 may be fixed relative to the housing component 100.

In practical applications, the outer connecting portion 413 may be connected and fixed by means of interference fit or adhesive bonding between an outer wall face of the outer connecting portion 413 and an inner wall face of the housing component 100. The outer connecting portion 413 may also abut against an internal bracket of the housing component 100 to achieve the fixation by means of interaction between the outer wall face of the outer connecting portion 413 and the inner wall face of the housing component 100.

The outer connecting portion 413 and the inner connecting portion 411 may be configured as any shape, such as an annulus, a rectangle, or an arc.

Preferably, the outer connecting portion 413 and the inner connecting portion 411 may be configured as an annulus. An outer diameter of the outer connecting portion 413 is approximately equivalent to an inner diameter of the housing component 100, such that a radial position of the outer connecting portion 413 may be restricted by means of interaction between the outer wall face of the outer connecting portion 413 and the inner wall face of the housing component 100, thereby ensuring accuracy of the radial position of the outer connecting portion 413. Furthermore, the annular inner connecting portion 411 also facilitates a rotational connection between the inner connecting portion 411 and the power output shaft 200. In practical applications, the outer diameter of the outer connecting portion 413 may be determined according to the inner diameter of the housing component 100, and the outer diameter of the outer connecting portion 413 may range between 17 mm and 20 mm.

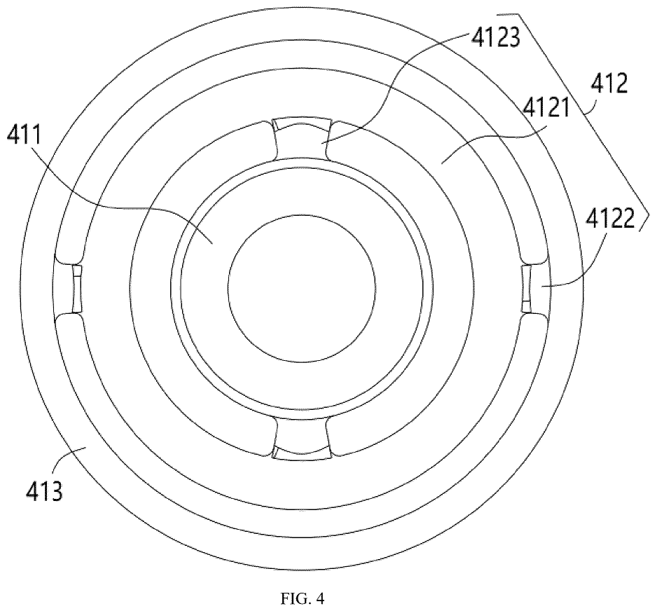

As shown in FIGS. 3 to 6, in an implementable embodiment, the deformation portion 412 may include a deformation body 4121, at least two first connecting arms 4122, and at least two second connecting arms 4123, where the deformation body 4121 is annular in shape. The deformation body 4121, the inner connecting portion 411, and the outer connecting portion 413 are coaxially spaced apart from each other, and the deformation body 4121 is positioned between the inner connecting portion 411 and the outer connecting portion 413. An outer wall face of the deformation body 4121 is connected to an inner wall face of the outer connecting portion 413 by means of the at least two first connecting arms 4122, and an inner wall face of the deformation body 4121 is connected to an outer wall face of the inner connecting portion 411 by means of the at least two second connecting arms 4123. In this way, reliability of connection between the inner connecting portion 411 and the outer connecting portion 413 may be ensured, thereby reducing possibility of breakage. Furthermore, by connecting the deformation body 4121, the inner connecting portion 411, and the outer connecting portion 413 by means of the connecting arms, overall resistance ability of the deformation portion 412 is reduced, such that when the power output shaft 200 is subjected to a force and moves in the direction of the first axis 101, the deformation portion 412 may produce an appropriate elastic deformation to allow the power output shaft 200 to move in the direction of the first axis 101.

In this embodiment, the at least two first connecting arms 4122 may be at least partially non-equidistantly spaced taking an axis of the deformation body 4121 as a center. Alternatively, the at least two second connecting arms 4123 may be at least partially non-equidistantly spaced taking the axis of the deformation body 4121 as a center.

Of course, the at least two first connecting arms 4122 may also be arranged in an annular array taking the axis of the deformation body 4121 as a center, and the at least two second connecting arms 4123 may be arranged in an annular array taking the axis of the deformation body 4121 as a center. The annular array arrangement refers to a layout mode in which the connecting arms are equidistantly arranged into an annular shape around a center point. In this way, when the power output shaft 200 drives the inner connecting portion 411 to move in the direction of the first axis 101, the inner connecting portion 411 may uniformly transmit the force to the deformation body 4121 by means of the at least two second connecting arms 4123, and the deformation body 4121 may uniformly transmit the force to the at least two first connecting arms 4122, such that the deformation portion 412 produces uniform elastic deformation, thus avoiding a problem of fracture caused by an uneven force.

In practical applications, number of the first connecting arms 4122 may be equal to or not equal to that of the second connecting arms 4123. When the number of the first connecting arms 4122 is equal to that of second connecting arms 4123, both the number of the first connecting arms 4122 and the number of second connecting arms 4123 may be two, three, four, five, six, or the like. A width of the deformation body 4121 may range between 1.4 mm and 2 mm.

The width D3 of the first connecting arm 4122 and the width D3 of the second connecting arm 4123 may both range between 1.3 mm and 1.8 mm, to ensure structural strength of the first connecting arm 4122 and the second connecting arm 4123.

For example, when both the number of the first connecting arms 4122 and the number of second connecting arms 4123 are two, a connecting line between the two first connecting arms 4122 is perpendicular to a connecting line between the two second connecting arms 4123. In this way, a distance between the first connecting arm 4122 and the second connecting arm 4123 adjacent to each other may be increased as much as possible, such that when the inner connecting portion 411 is subjected to an acting force along the direction of the first axis 101, the deformation portion 412 can produce a larger elastic deformation to meet a distance requirement of the power output shaft 200 moving along the direction of the first axis 101.

To further improve degree of the elastic deformation of the deformation portion 412, as shown in FIG. 6, in one implementable embodiment, for ease of description, in the present disclosure, part of the deformation body 4121 positioned between any adjacent two of the first connecting arms 4122 and the second connecting arms 4123 is defined as a deformation segment 41211 (a part divided by two dashed lines in FIG. 6), and the deformation segment 41211 is in the shape of an arc-shaped segment. Along an extension direction of the deformation segment 41211, a thickness of the deformation segment 41211 gradually increases from a middle region of the deformation segment 41211 to two ends of the deformation segment 41211. That is, the thickness at a connection between the deformation body 4121 and the first connecting arm 4122 and the second connecting arm 4123 is larger, and the thickness gradually decreases towards a direction away from the connection between the deformation body 4121 and the first connecting arm 4122 and the second connecting arm 4123. Therefore, by means of an unequal thickness design, the deformation body 4121 may further undergo a certain degree of elastic deformation in a region where the thickness is smaller, thereby improving the degree of the elastic deformation of the deformation portion 412. Moreover, the thickness at the connection between the first connecting arm 4122 and the second connecting arm 4123 is increased, to ensure overall structural reliability of the first auxiliary member 410, thereby avoiding the problem of fracture at the connection.

In practical applications, a thickness D1 between the two ends of the deformation segment 41211 ranges between 0.7 mm and 1.1 mm, and a thickness D2 of the middle region of the deformation segment 41211 ranges between 0.3 mm and 0.5 mm. In this way, the overall structural reliability of the first auxiliary member 410 may be ensured while improving the degree of the elastic deformation of the deformation portion 412.

As shown in FIG. 3, in one implementable embodiment, the axial auxiliary component 400 may also include a first bearing 420. An inner ring of the first bearing 420 is sleeved on the power output shaft 200, and an outer ring of the first bearing 420 is fixedly connected to the inner connecting portion 411, such that the inner connecting portion 411 is rotatably connected to the power output shaft 200 by means of the first bearing 420. In this way, the first bearing 420 may be used to reduce the friction between the inner connecting portion 411 and the power output shaft 200, to avoid relative wear between the inner connecting portion 411 and the power output shaft 200, thereby prolonging the service life. Furthermore, a resistance force generated by the inner connecting portion 411 against the rotation of the power output shaft 200 may be reduced, thereby ensuring stable movement of the power output shaft 200.

In practical applications, the inner ring of the first bearing 420 may be fixed to the power output shaft 200 and the outer ring of the first bearing 420 may be fixed to the inner connecting portion 411 by means of press-fit with adhesive or other connection manners, but the present disclosure is not limited thereto.

In one implementable embodiment, the inner connecting portion 411 is annular in shape, and the inner connecting portion 411 is provided with a first opening and a second opening at two ends along the first axis 101, respectively. One end of the inner connecting portion 411 adjacent to the first opening is provided with a carrying portion 414, and the carrying portion 414 extends radially inward from an inner wall face of the inner connecting portion 411. The first bearing 420 may be installed into an interior of the inner connecting portion 411 through the second opening, and the carrying portion 414 abuts against a side surface of the outer ring of the first bearing 420, and the carrying portion 414 does not extend to the inner ring of the first bearing 420. That is, the carrying portion 414 does not affect the rotational motion of the power output shaft 200, but when the power output shaft 200 moves along a direction of the first axis 101 towards the carrying portion 414, the power output shaft 200 may push against the carrying portion 414 by means of the first bearing 420 to drive the inner connecting portion 411 to move, thereby causing the deformation portion 412 to produce the elastic deformation. In this way, the carrying portion 414 may carry the acting force applied by the power output shaft 200 along the direction of the first axis 101 towards the carrying portion 414 of the first auxiliary member 410, thereby avoiding the problem of failure of connection between the power output shaft 200 and the inner connecting portion 411 resulted from a force applied to the connection between the power output shaft 200 and the inner wall face of the inner connecting portion 411, thereby improving service reliability of the drive apparatus and prolonging the service life of the drive apparatus.

In practical applications, the carrying portion 414 may be annular in shape, and the carrying portion 414 is arranged around the inner ring of the first opening. A diameter of an inner hole of the carrying portion 414 should not be smaller than a diameter of the power output shaft 200, such that the power output shaft 200 can pass through the inner hole of the carrying portion 414. Of course, the carrying portion 414 may also be comprised of at least two blockers.

Regarding to an arrangement position of the deformation portion 412 on the inner connecting portion 411, in one implementable embodiment, along a direction parallel to the first axis 101, the deformation portion 412 may be positioned at a middle position of the inner connecting portion 411, or may be positioned away from the carrying portion 414.

As shown in FIG. 3, in another alternative embodiment, along the direction parallel to the first axis 101, the deformation portion 412 is arranged adjacent to the carrying portion 414.

It is to be understood that when the power output shaft 200 moves along the direction of the first axis 101 towards the carrying portion 414, the power output shaft 200 mainly acts on the carrying portion 414. That is, a force bearing point of a main acting force exerted by the power output shaft 200 on the inner connecting portion 411 is positioned at one end of the carrying portion 414. By arranging the deformation portion 412 adjacent to the carrying portion 414, a distance between the deformation portion 412 and the force bearing point of the main acting force may be reduced, thereby shortening an arm of force of the deformation portion 412 in the axial direction and thus reducing a torque of the deformation portion 412 along a radial direction. In this way, it is avoided the problem of tensile fracture of the deformation portion 412 in the radial direction, and thus prolonging the service life of the first auxiliary member 410.

As shown in FIG. 2, in one implementable embodiment, the axial auxiliary component 400 may also include a second auxiliary member 430. The first auxiliary member 410 and the second auxiliary member 430 are arranged along the first axis 101, where the first auxiliary member 410 and the second auxiliary member 430 have the same structure and are symmetrically arranged about a middle plane between the first auxiliary member 410 and the second auxiliary member 430. In this way, the carrying portion 414 of the first auxiliary member 410 and the carrying portion 414 of the second auxiliary member 430 are also symmetrically arranged. Therefore, when the power output shaft 200 moves in any direction along the first axis 101, there is one carrying portion 414 that carries the acting force applied by the power output shaft 200 along the first axis 101, which further avoids the problem of failure of connection between the power output shaft 200 and the inner connecting portion 411 resulted from the force applied to the connection between the power output shaft 200 and the inner wall face of the inner connecting portion 411, thereby improving the service reliability of the drive apparatus and prolonging the service life of the drive apparatus.

In practical applications, the second auxiliary member 430 is also connected to the power output shaft 200 by means of a bearing, and a side surface of the outer ring of the bearing abuts against the carrying portion 414 of the second auxiliary member 430. The first auxiliary member 410 and the second auxiliary member 430 may be positioned at two opposite ends of the servo rotating assembly 500 along the first axis 101, where the first auxiliary member 410 is positioned between the servo rotating assembly 500 and the axial drive component 300.

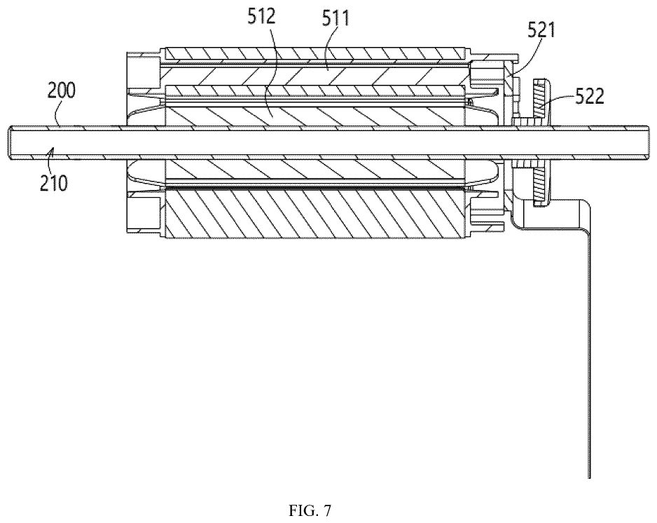

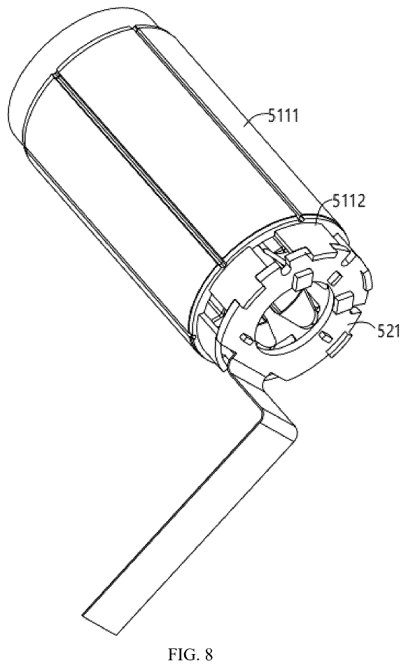

Regarding to the specific structure of the servo rotating assembly 500, as shown in FIGS. 7 and 8, in one implementable embodiment, the servo rotating assembly 500 includes a rotary drive component 510 and a motion detection component 520. The rotary drive component 510 includes a stator element 511 fixedly connected to the housing component 100 and a rotor element 512 fixedly connected to the power output shaft 200, where the stator element 511 is arranged at least partially surrounding the rotor element 512. When the stator element 511 is energized, a magnetic field generated by the stator element 511 couples with a magnetic field generated by the rotor element 512 to form a rotating magnetic field. When the rotating magnetic field changes, the rotor element 512 drives the power output shaft 200 to rotate to achieve the rotational motion.

The motion detection component 520 is at least partially positioned in the accommodation chamber 102. The motion detection component 520 includes a motion detection member 521 and a motion feedback member 522. The motion detection member 521 is directly connected to the stator element 511, and the motion feedback member 522 is connected to the power output shaft 200 and rotates with the power output shaft 200. The motion detection member 521 determines a rotational position of the power output shaft 200 by means of the motion feedback member 522, thereby achieving the servo control function. In practical applications, the motion detection member 521 may include a circuit board and a position sensor integrated on the circuit board, where the position sensor may be a laser sensor or a Hall sensor, etc., but the present disclosure is not limited thereto. The motion detection member 521 may be connected to a control component outside the accommodation chamber 102 through wiring harness such as wires or FPC (Flexible Printed Circuit) connecting wires.

It is worth mentioning that compared to the related technology in which similarly it is required for twice positioning assembly processes when the motion detection member 521 is connected to the housing component 100 through a corresponding support, in the present disclosure, the motion detection member 521 in the drive apparatus is directly connected to the stator element 511, such that the motion detection member 521 only needs one positioning installation operation to complete the positioning assembly, which simplifies the assembly process, significantly reduces complexity of the assembly, and solves the problem of larger assembly accuracy difference caused by multiple assembly operations. When the drive apparatus is used in the oral cleaner such as the electric toothbrush and the integrated rinsing machine, the improvement scheme of the present disclosure can greatly improve consistency in the assembly accuracy of the motion detection member 521, which helps to provide a control effect for a cleaning motion of the electric toothbrush and improve the user experience.

Furthermore, the motion detection component 520 comprised of the motion detection member 521 and the motion feedback member 522 is installed inside the accommodation chamber 102. That is, the motion detection component 520 is built into the housing component 100, which avoids formation of an outward expanding structure outside the housing component 100, thereby reducing the overall size of the drive apparatus, and thus achieving a more compact miniaturization design. When the drive apparatus is used in the oral cleaner such as the electric toothbrush and the integrated rinsing machine, the compact structure of the present disclosure not only makes the oral cleaner thinner to optimize aesthetics of the electric toothbrush, but also leaves a larger water storage space inside the oral cleaner to accommodate more flushing liquid, thus enhancing overall functionality of the product.

Further, the stator element 511 may include a stator bracket 5111 and a surface covering element 5112. The surface covering element 5112 at least covers the stator bracket 5111 to form an insulation layer, thereby preventing current leakage and accidental short circuits. The motion detection member 521 is directly connected to the surface covering element 5112. In practical applications, a material of the surface covering element 5112 may be plastic, rubber, or thermoplastic elastomer.

It is worth mentioning that the surface covering element 5112 is integrated with the stator bracket 5111 by means of injection molding. That is, the surface covering element 5112 is formed by means of injection molding, which can achieve higher manufacturing accuracy. In this way, accuracy of assembly between the motion detection member 521 and the surface covering element 5112 may be further improved, thereby improving control performance of the drive apparatus and further ensuring consistency in swing of the brush head.

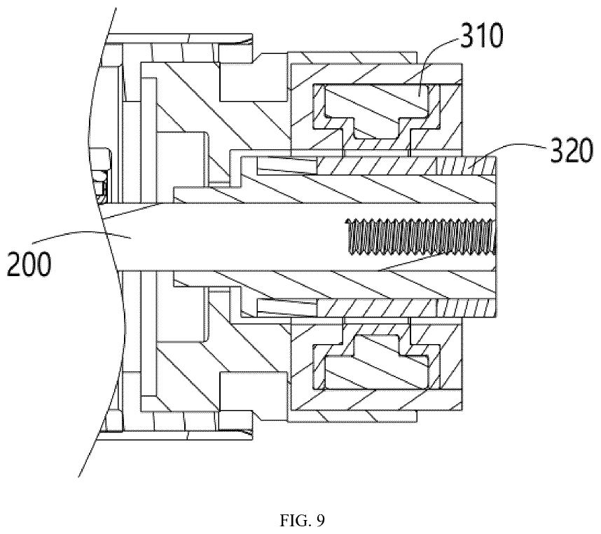

Regarding to the specific structure of the axial drive component 300, as shown in FIG. 9, in one implementable embodiment, the axial drive component 300 includes a primary element 310 and a secondary element 320, where the primary element 310 is fixedly connected to the housing component 100, and the secondary element 320 is sleeved on the power output shaft 200 and rotates with the power output shaft 200. When electric current flows through the primary element 310, a magnetic field generated by the primary element 310 couples with a magnetic field generated by the secondary element 320 to form a traveling magnetic field. When the traveling magnetic field changes, the secondary element 320 may drive the power output shaft 200 to move along the first axis 101.

In practical applications, reference may be made to the structure of an existing axial linear motor for the specific structure of the axial drive component 300, which is not to be described in detail herein.

In one implementable embodiment, the housing component 100 may be an integrated structure, and the housing component 100 is provided, along one end of the first axis 101, with an opening communicating with the accommodation chamber 102. The axial drive component 300, the axial auxiliary component 400, and the servo rotating assembly 500 are separately installed in the housing component 100 through the opening.

In another alternative embodiment, as shown in FIG. 2, the housing component 100 may also adopt a multi-segment splicing structure. Specifically, the housing component 100 may include an outer housing 110 and an attachment segment 120. The outer housing 110 has an opening at one end along the first axis 101, and the attachment segment 120 is annular in shape. One end of the attachment segment 120 inserted into the outer housing 110 along the first axis 101 is provided with an opening, and the attachment segment 120 is coaxially arranged with the outer housing 110.

In practical applications, the second auxiliary member 430 may be first installed, through the opening of the outer housing 110, into an chamber enclosed by the outer housing 110, and then the rotary drive component 510, the motion detection component 520, and the first auxiliary member 410 may be sequentially installed, through the opening of the outer housing 110, into the chamber enclosed by the outer housing 110. Next, the attachment segment 120 is inserted into the opening of the outer housing 110, and the axial drive component 300 is installed.

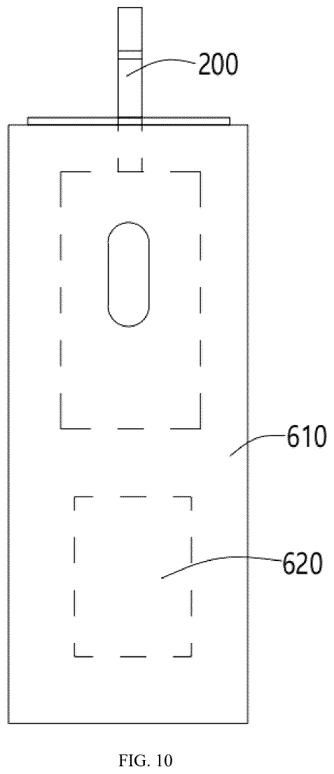

As shown in FIG. 10, based on the same inventive concept, the present disclosure also provides a brush handle assembly. Specifically, the brush handle assembly may at least include a grip housing 610, an energy storage member 620 installed inside the grip housing 610, and the drive apparatus for oral cavity cleaning. The energy storage member 620 is electrically connected to the drive apparatus, and the power output shaft 200 of the drive apparatus extends out of the grip housing 610.

In practical applications, to make it easier for the user to grip, the grip housing 610 may be shaped like a slender body, and a cross-sectional shape of the grip housing 610 may be circular or non-circular (such as D-shaped, elliptical, or polygonal). Reference may be made to an existing battery for the specific structure of the energy storage member 620, which is not to be described in detail herein.

In one implementable embodiment, the brush handle assembly may be used, as a power portion and a grip portion, in the oral cleaner such as the electric toothbrush. When the brush handle assembly is used in the oral cleaner, the power output shaft 200 of the brush handle assembly is detachably connected to an oral care head 650 (an accessory provided with bristles such as a toothbrush head), such that the power output shaft 200 drives the oral care head 650 to move.

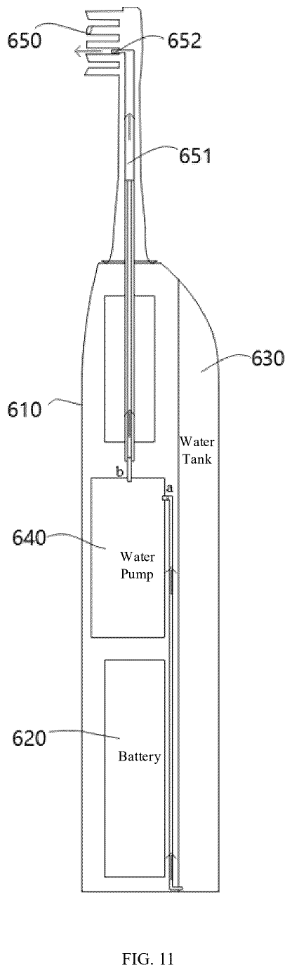

Further, as shown in FIGS. 7 and 11, the brush handle assembly may also integrate swing and flushing functions, and may be used in the integrated rinsing machine. Specifically, the brush handle assembly also includes a liquid storage chamber 630 and a fluid pumping unit 640 positioned inside the grip housing 610. The power output shaft 200 has an axial channel 210, and a fluid inlet and a fluid inlet outlet communicating with the axial channel 210. The fluid inlet of the axial channel 210 can communicate with the liquid storage chamber 630, and the fluid pumping unit 640 is connected in series with the fluid inlet of the axial channel 210 and a flow channel of the liquid storage chamber 630, such that the fluid pumping unit 640 can pump the fluid in the liquid storage chamber 630, and the fluid flows out of the fluid outlet of the axial channel 210 through the axial channel 210.

In one implementable embodiment, the brush handle assembly may be used in the oral cleaner such as the integrated rinsing machine. When the brush handle assembly is used in the oral cleaner, the oral care head 650 (an accessory provided with bristles such as an integrated rinsing head) of the oral cleaner has a fluid channel 651 and an outlet 652 communicating with the fluid channel 651. The power output shaft 200 is connected to the oral care head 650 and drives the oral care head 650 to perform a displacement motion, and the fluid outlet of the axial channel 210 communicates with the fluid channel 651. The oral cleaner outputs water flow impact through the outlet 652.

It should be pointed out that reference may be made to the detailed description recorded in the above embodiments for the specific structure of the drive apparatus, which is not to be described in detail herein.

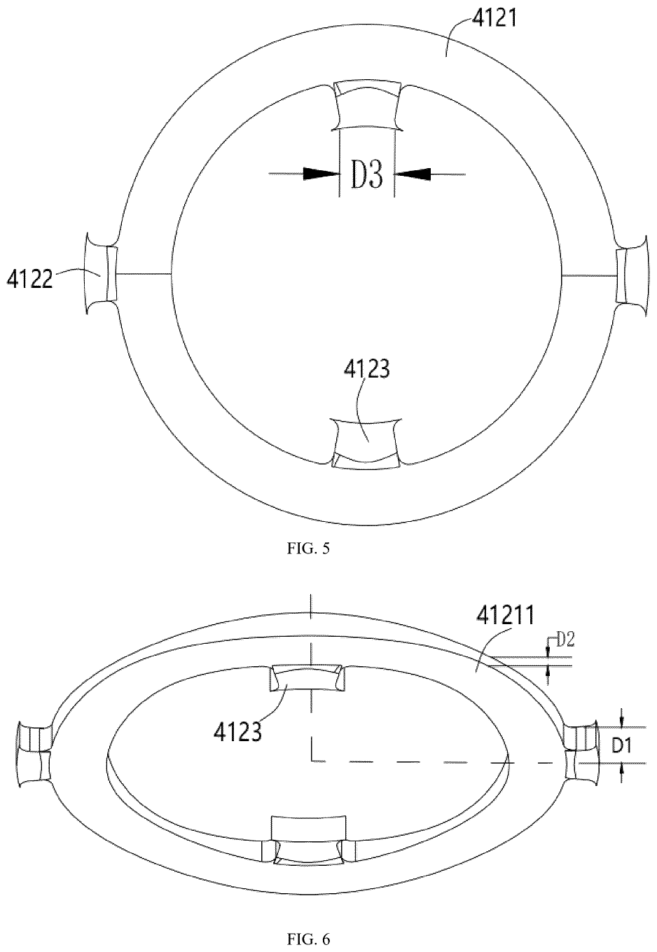

Based on the same inventive concept, as shown in FIGS. 4 to 6, the present disclosure also provides an axial auxiliary member, which at least includes an inner connecting portion 411, a deformation portion 412, and an outer connecting portion 413. The inner connecting portion 411 and the outer connecting portion 413 are both annular in shape, the inner connecting portion 411 is positioned inside the outer connecting portion 413, and the inner connecting portion 411 is coaxially spaced apart from the outer connecting portion 413. The deformation portion 412 is separately connected to the inner connecting portion 411 and the outer connecting portion 413, and the deformation portion 412 has elastic properties.

Further, the deformation portion 412 includes an annular deformation body 4121, where the deformation body 4121 is positioned between the inner connecting portion 411 and the outer connecting portion 413, and the deformation body 4121 is coaxially spaced apart from the inner connecting portion 411 and the outer connecting portion 413, respectively. An outer wall face of the deformation body 4121 is connected to an inner wall face of the outer connecting portion 413 by means of at least two first connecting arms 4122, and an inner wall face of the deformation body 4121 is connected to an outer wall face of the inner connecting portion 411 by means of at least two second connecting arms 4123.

Further, two of the first connecting arms 4122 and two of the second connecting arms 4123 are provided, and a connecting line between the two first connecting arms 4122 is perpendicular to a connecting line between the two second connecting arms 4123.

It should be pointed out that reference may be made to the detailed description recorded in the first auxiliary member 410 for the specific structure of the axial auxiliary member, which is not to be described in detail herein.

The terms such as “upper” and “lower” for describing relative positional relationships of various structures in the drawings are merely for the purpose of concise description rather than limiting the implementable scope of the present disclosure. The changes or adjustments of the relative relationship without a substantial modification to the technical solutions are regarded as being covered by the implementable scope of the present disclosure.

It is to be noted that in the present disclosure, unless specified or limited otherwise, a first feature “on” or “below” a second feature may include an embodiment in which the first feature is in direct contact with the second feature, and may also include an embodiment in which the first feature and the second feature are in indirect contact via an intermediary. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. A first feature “below,” “under,” or “on bottom of” a second feature may include an embodiment in which the first feature is right or obliquely “below,” “under,” or “on bottom of” the second feature, or just means that the first feature is at a height lower than that of the second feature.

In addition, in the present disclosure, unless specified or limited otherwise, terms “mounted”, “connected”, “coupled”, “fixed” and so on should be understood in a broad sense, which may be, for example, a fixed connection, a detachable connection or integrated connection, a direct connection or indirect connection by means of an intermediary, an internal communication between two elements or an interaction relationship between two elements. The specific significations of the above terms in the present disclosure may be understood in the light of specific conditions by persons of ordinary skill in the art.

Reference throughout this specification to the terms “an embodiment,” “some embodiments,” “an exemplary embodiment,” “an example,” “a specific example,” or “some examples,” means that a specific feature, structure, material, or characteristic described in connection with the embodiment or example is included in at least one embodiment or example of the present disclosure. The schematic representation of the above terms throughout this specification is not necessarily referring to the same embodiment or example. Furthermore, the specific features, structures, materials, or characteristics set forth may be combined in any suitable manner in one or more embodiments or examples.

Finally, it is to be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, which does not make corresponding technical solutions in essence depart from the scope of the technical solutions of the embodiments of the present disclosure.

What is claimed is:

1. A drive apparatus for oral cavity cleaning at least comprising a housing component (100), a power output shaft (200), an axial drive component (300), an axial auxiliary component (400), and a servo rotating assembly (500), wherein
the housing component (100) extends along a first axis (101) and has an accommodation chamber (102);
the axial drive component (300), the axial auxiliary component (400), and the servo rotating assembly (500) are arranged along the first axis (101), and the axial auxiliary component (400) and the servo rotating assembly (500) are at least partially positioned in the accommodation chamber (102), the power output shaft (200) extends along the first axis (101) and passes through the axial drive component (300), the axial auxiliary component (400), and the servo rotating assembly (500), respectively, and at least one end of the power output shaft (200) extends out of the housing component (100); and
the axial auxiliary component (400) is connected to the power output shaft (200) and the housing component (100), respectively, and when the axial drive component (300) drives the power output shaft (200) to move along the first axis (101), the axial auxiliary component (400) is configured to move along the first axis (101) against the power output shaft (200), to limit a movement range of the power output shaft (200) on the first axis (101).

2. The drive apparatus for oral cavity cleaning according to claim 1, wherein the axial auxiliary component (400) comprises a first auxiliary member (410), and the first auxiliary member (410) comprises an inner connecting portion (411) rotatably connected to the power output shaft (200) and a deformation portion (412) connecting the inner connecting portion (411) and the housing component (100); and
when the axial drive component (300) drives the power output shaft (200) to move along the first axis (101), a driving force of the axial drive component (300) overcomes an elastic force of the deformation portion (412) to cause elastic deformation of the deformation portion (412), and the elastic force of the deformation portion (412) limits the movement range of the power output shaft (200) on the first axis (101).

3. The drive apparatus for oral cavity cleaning according to claim 2, wherein the first auxiliary member (410) further comprises an outer connecting portion (413); and
the outer connecting portion (413) is connected to the inner connecting portion (411) by means of the deformation portion (412) to form an integrated structure, such that the deformation portion (412) is connected to the housing component (100) by means of the outer connecting portion (413).

4. The drive apparatus for oral cavity cleaning according to claim 3, wherein the deformation portion (412) comprises a deformation body (4121), the deformation body (4121), the inner connecting portion (411), and the outer connecting portion (413) are annular in shape and are coaxially spaced apart from each other, and the deformation body (4121) is positioned between the inner connecting portion (411) and the outer connecting portion (413); and
an outer wall face of the deformation body (4121) is connected to an inner wall face of the outer connecting portion (413) by means of at least two first connecting arms (4122), and an inner wall face of the deformation body (4121) is connected to an outer wall face of the inner connecting portion (411) by means of at least two second connecting arms (4123).

5. The drive apparatus for oral cavity cleaning according to claim 4, wherein the at least two first connecting arms (4122) are arranged in an annular array taking an axis of the deformation body (4121) as a center, and the at least two second connecting arms (4123) are arranged in an annular array taking the axis of the deformation body (4121) as a center.

6. The drive apparatus for oral cavity cleaning according to claim 5, wherein two of the first connecting arms (4122) and two of the second connecting arms (4123) are provided, and a connecting line between the two first connecting arms (4122) is perpendicular to a connecting line between the two second connecting arms (4123).

7. The drive apparatus for oral cavity cleaning according to claim 6, wherein part of the deformation body (4121) positioned between any adjacent two of the first connecting arms (4122) and the second connecting arms (4123) is defined as a deformation segment (41211); and
along an extension direction of the deformation segment (41211), a thickness of the deformation segment (41211) gradually increases from a middle region of the deformation segment (41211) to two ends of the deformation segment (41211).

8. The drive apparatus for oral cavity cleaning according to claim 7, wherein a thickness (D1) between the two ends of the deformation segment (41211) ranges between 0.7 mm and 1.1 mm; and
a thickness (D2) of the middle region of the deformation segment (41211) ranges between 0.3 mm and 0.5 mm.

9. The drive apparatus for oral cavity cleaning according to claim 4, wherein a width (D3) of the first connecting arm (4122) and a width (D3) of the second connecting arm (4123) both range between 1.3 mm and 1.8 mm.

10. The drive apparatus for oral cavity cleaning according to claim 3, wherein the axial auxiliary component (400) further comprises a first bearing (420); and
an inner ring of the first bearing (420) is sleeved on the power output shaft (200), and an outer ring of the first bearing (420) is fixedly connected to the inner connecting portion (411), such that the inner connecting portion (411) is rotatably connected to the power output shaft (200) by means of the first bearing (420).

11. The drive apparatus for oral cavity cleaning according to claim 10, wherein the inner connecting portion (411) is annular in shape, and the inner connecting portion (411) is provided with a first opening and a second opening at two ends along the first axis (101), respectively;
one end of the inner connecting portion (411) adjacent to the first opening is provided with a carrying portion (414), and the carrying portion (414) extends radially inward from an inner wall face of the inner connecting portion (411); and
the first bearing (420) is installed into an interior of the inner connecting portion (411) through the second opening, and the carrying portion (414) abuts against the outer ring of the first bearing (420), and the carrying portion (414) does not extend to the inner ring of the first bearing (420).

12. The drive apparatus for oral cavity cleaning according to claim 11, wherein in a direction parallel to the first axis (101), the deformation portion (412) is arranged adjacent to the carrying portion (414).

13. The drive apparatus for oral cavity cleaning according to claim 12, wherein the axial auxiliary component (400) further comprises a second auxiliary member (430); and
the first auxiliary member (410) and the second auxiliary member (430) are arranged along the first axis (101), and the first auxiliary member (410) and the second auxiliary member (430) have a same structure and are symmetrically arranged about a middle plane between the first auxiliary member (410) and the second auxiliary member (430).

14. The drive apparatus for oral cavity cleaning according to claim 1, wherein the servo rotating assembly (500) comprises a rotary drive component (510) and a motion detection component (520);
the rotary drive component (510) comprises a stator element (511) and a rotor element (512), the stator element (511) is fixedly connected to the housing component (100), and the rotor element (512) is fixedly connected to the power output shaft (200); and
the motion detection component (520) positioned at least partially in the accommodation chamber (102) comprises a motion detection member (521) and a motion feedback member (522), the motion detection member (521) is directly connected to the stator element (511), the motion feedback member (522) is connected to the power output shaft (200) and rotates with the power output shaft (200), and the motion detection member (521) is configured to detect a rotational position of the power output shaft (200) by means of the motion feedback member (522).

15. The drive apparatus for oral cavity cleaning according to claim 14, wherein the stator element (511) comprises a stator bracket (5111) and a surface covering element (5112), the surface covering element (5112) at least covers the stator bracket (5111), and the motion detection member (521) is connected to the surface covering element (5112).

16. The drive apparatus for oral cavity cleaning according to claim 1, wherein the axial drive component (300) comprises a primary element (310) and a secondary element (320); and
the primary element (310) is fixedly connected to the housing component (100), the secondary element (320) is annular in shape, and the secondary element (320) is sleeved on the power output shaft (200) and rotates with the power output shaft (200).

17. An oral cleaner at least comprising an oral care head (650) and a brush handle assembly; wherein, the brush handle assembly at least comprising a grip housing (610), an energy storage member (620) installed inside the grip housing (610), and the drive apparatus for oral cavity cleaning according to claim 1; the energy storage member (620) is electrically connected to the drive apparatus, and the power output shaft (200) of the drive apparatus extends out of the grip housing (610); the power output shaft (200) has an axial channel (210) and a fluid inlet and a fluid outlet communicating with the axial channel (210);
the oral care head (650) has a fluid channel (651) and an outlet (652) communicating with the fluid channel (651), the power output shaft (200) is connected to the oral care head (650) and drives the oral care head (650) to perform a displacement motion, and a fluid outlet of the axial channel (210) communicates with the fluid channel (651), and the oral cleaner outputs water flow impact through the outlet (652).

18. An axial auxiliary member at least comprising an inner connecting portion (411), a deformation portion (412), and an outer connecting portion (413), wherein
the inner connecting portion (411) and the outer connecting portion (413) are both annular in shape, the inner connecting portion (411) is positioned inside the outer connecting portion (413), and the inner connecting portion (411) is coaxially spaced apart from the outer connecting portion (413); and
the deformation portion (412) is separately connected to the inner connecting portion (411) and the outer connecting portion (413), and the deformation portion (412) has elastic properties.

19. The axial auxiliary member according to claim 18, wherein the deformation portion (412) comprises an annular deformation body (4121) positioned between the inner connecting portion (411) and the outer connecting portion (413), and the deformation body (4121) is coaxially spaced apart from the inner connecting portion (411) and the outer connecting portion (413), respectively; and
an outer wall face of the deformation body (4121) is connected to an inner wall face of the outer connecting portion (413) by means of at least two first connecting arms (4122), and an inner wall face of the deformation body (4121) is connected to an outer wall face of the inner connecting portion (411) by means of at least two second connecting arms (4123).

20. The axial auxiliary member according to claim 19, wherein two of the first connecting arms (4122) and two of the second connecting arms (4123) are provided, and a connecting line between the two first connecting arms (4122) is perpendicular to a connecting line between the two second connecting arms (4123).
